(19) United States
(12) Patent Application Publication
(10) Pub. No.: US 2012/0167897 A1
(43) Pub. Date: Jul. 5, 2012

(54) TISSUE PROTECTOR

(75) Inventor: Remo Bettega, Diepoldsau (CH)

(73) Assignee: HIBRAND ESTABLISHMENT, Schaan ,Liechtenstein (LI)

(21) Appl. No.: 13/394,808

(22) PCT Filed: Jun. 2, 2010
(86) PCT No.: PCT/EP2010/057751

§ 371 Date: Mar. 7, 2012

(30) Foreign Application Priority Data
Sep. 7, 2009 (EP) 09169625.2

(51) Int. Cl. A61C 5/14

(52) U.S. Cl. 128/860; 128/859

(57) ABSTRACT

The invention refers to a tissue protector for protecting healthy tissue of a patient from radiation exposure during teletherapy, comprising a jaw part for generating a raised bite, and a soft-tissue positioning part connected to said jaw part for positioning a soft-tissue of said patient, said jaw part having an opening for visual control of a surgical area of said patient.

The present invention refers to a tissue protector for preventing healthy tissue in the immediate vicinity of a tumor from being damaged by radiation exposure in the course of a tele- or brachytherapy, i.e. a tumor therapy, where the patient's body is exposed to suitable radiation from the outside, or where the radiation source is positioned within or directly attached on the body, respectively. Specifically, the invention refers to a tissue protector for preventing healthy tissue of the oral cavity and the mean pharyngeal area from being damaged.

What alternatives for protecting the healthy tissue there are depend on the kind of therapy in question: Teletherapy, also termed external radiation therapy, or brachytherapy, also termed internal radiation therapy.

For example, for the tele-therapeutical treatment of certain types of tumors, e.g. the squameous-cell carcinoma or the adenocarcinoma of the head and neck region, specifically the area of the mouth floor or, similarly, the paranasal sinuses, not only parts of the tongue but the complete tongue being soft-tissue—i.e. also its border or marginal areas—should be exposed to radiation. In rest position, i.e. in occlusion position, the tongue usually projects over the teeth of the lower jaw and rests against the hard palate. During radiation without change of the position of the tongue, therefore, the teeth—especially the teeth's crowns—would also be exposed to radiation, which may cause severe damage to the tooth enamel, and, as a further consequence, even the loss of previously healthy teeth. Furthermore, there has been observed a so-called osteoradionecrosis of the jawbones—that is a die-off (necrosis) of bone substance induced by radiation exposure—, specifically after the extraction of a tooth from the exposed bone, which occasionally leads to a loss of large parts of a jaw and thus, besides the directly involved medical and everyday-life problems, to diminished quality of the patient's life, i.e. to a iatrogenic physical as well as psychological impairment. In such a situation, the tissue to be treated is a soft-tissue that has to be brought into and held in a reproducible position during each session of a treatment possibly requiring several sessions. It is, however, also conceivable that healthy soft-tissue has to be held out of the effective range of the radiation, i.e. kept away therefrom, in order to make sure that the healthy soft-tissue does not even temporarily obstruct the beam path between the radiation source and the tissue to be treated. In the case of soft-tissue during teletherapy, a distinction has to be made, therefore, between a case in which the soft-tissue has to be held in a well-defined and reproducible position for its own treatment, and a case in which the soft-tissue has to be kept outside of the effective range of the radiation for its protection during treatment of a surrounding tissue.

Other precautions have to be taken during brachytherapy, which depend on whether the radiation source is introduced directly into the tumor tissue (interstitial brachytherapy) or is arranged directly adjacent the tumor tissue (contact brachytherapy), for example, or whether the brachytherapy is temporary or permanent.

The duration of a radiation treatment (teletherapy or temporary brachytherapy) depends on many factors such as the type and location of the tumor, for example. Treatment may require up to 30 sessions, so that it may span several weeks, with the actual exposure time per session being 2 to 3 minutes, and the complete session lasting up to 15 minutes.

It is, therefore, an object of the present invention to provide a device—referred to herein as a tissue protector—, the device being intended to serve a dual function:
1. It shall assure an unvarying raised bite (i.e. a vertical increase of the distance between upper and lower jaws, also called non-occlusion) of the jaws and allow for visual control of the treatment; and
2. During a session, it shall be adapted to maintain a soft-tissue in a position (a) that is well-defined and reproducible if the soft tissue itself is to be treated, and (b) in which the soft-tissue is held outside the effective range of the radiation if the soft-tissue shall be radiation-protected during treatment of surrounding tissue. A combination of (a) and (b) is possible. In other words, it may be necessary to additionally keep the patient's cheeks out of the effective range of the radiation.

This objection is achieved through the features of claims 1 and 12, respectively.

According to the present invention, a tissue protector for protecting healthy tissue of the patient from radiation exposure during teletherapy comprises a jaw part for generating a raised bite, and a soft-tissue positioning part connected to the jaw part for positioning a soft-tissue of the patient, the jaw part having an opening for visual control of a surgical area of the patient. The position of the tumor determines the optical axis of the radiation that may, but need not, extend through the opening, for the jaw part is preferably made, at least in its frontal section, of a material that does not obstruct irradiation and thus only insignificantly absorbs and scatters the applied wavelength(s). The radiation used according to the invention preferably is an electromagnetic multifield radiation (x-rays) having an energy in the range of 4-20 MeV that can penetrate deeply (up to 2 cm) the tissue. 4-20 MeV does, however, only represent a rough indication, the actual value may deviate from this value in individual cases. The jaw part of the inventive tissue protector performs two tasks. On the one hand, it should generate an raised bite, optionally in conjunction with the soft-tissue positioning part, to thus move the teeth of the upper jaw out of the radiation field. On the other hand, it serves as an attachment means to reproducibly and stably establish an exact position of the tissue protector, above all the soft-tissue positioning part, within the mouth.

According to a preferred aspect of the present invention, there is provided a detachable connection between the jaw part and the soft-tissue positioning part. This is advantageous, firstly, because both parts can be manufactured independently from each other, so that the manufacture may be adapted to respective different materials for the jaw part and the soft-tissue part, respectively, and, secondly, because thereby the insertion of the inventive tissue protector into the patient's mouth is facilitated in that the tow parts are inserted into the mouth successively and are only connected to each other in situ. As an alternative, however, and as is expressed in a general way in claim 1 of the present invention, the jaw part and the soft-tissue part may be realized integrally, i.e. in the form of a monobloc.

According to a preferred aspect of the present invention, the connection between the jaw part and the soft-tissue positioning part is of the type of a male part- female part-system, wherein both parts are intraorally connected to each other by plugging the male part having a suitable protrusion into the female part having a complementarily formed groove, forming thereby a press or tight fit.

According to a preferred aspect of the present invention, the female part is formed in the soft-tissue positioning part, and the male part is formed in the jaw part. The reverse variant is, however, equivalent. The male part- female part-connection extends along the contact area between the jaw part and the soft-tissue positioning part, i.e. in the case of the jaw and soft-tissue positioning parts having the form of a dental arch it also extends in the form of a dental arch, advantageously along the entire length thereof of about 40 mm as a tongue-and-groove joint, wherein in a sectional view perpendicular to the longitudinal extension, the contact area between the jaw and soft-tissue positioning part preferably has the appearance of a line bent in a S-shaped manner. The male part- female part-connection may, however, be formed in any different way as long as a shifting or slipping, i.e. a relative movement between the jaw part and the soft-tissue positioning part during treatment can not occur, as is the case in the aspect of the present invention described above. The advantageous dental arch shaped embodiment is beneficial in that the pressure for maintaining the raised bite is advantageously distributed to all the teeth of the upper jaw or, in case of an edentulous person, to the entire arch of the gums. In addition, an exact position within the patient's mouth can be defined easily, and reproducibility of that position can be assured, so that the jaw part will remain in that position during the session and can be restored into that position during following sessions.

It should be noted that the terminology chosen herein and referring to medical (dental) terms of direction and location (e.g. “caudal”) as well as to the general human anatomy (e.g. dental arch shaped), implicitely defines a correct position on a person in the inserted condition of the tissue protector or a shape adapted to the human anatomy, respectively.

According to a preferred aspect of the present invention, the soft-tissue positioning part comprises a tongue part for depressing the patient's tongue, with the tongue part advantageously comprising a tongue depressing portion connected to the male part. This connection advantageously is formed in one piece. In view of the problem presented by the teeth during teletherapeutical treatment of the tongue described above, the tissue protector according to this advantageous aspect can be referred to as tissue protector.

According to a preferred aspect of the present invention, the tongue depressing portion has an essentially tongue-shaped or spoon-like frontal cross section, allowing for the tongue to be depressed in an anatomically uniform manner, specifically two-dimensionally and not in a punctiform manner. The tongue depressing portion may cover the tongue either completely or partially, e.g. only a front or only a rear part thereof. As mentioned above, the tongue depressing portion is preferably made of a material that is essentially transparent and non-scattering for the wavelength range of the radiation used, wherein the transparency property determines the total amount of energy passing through the inventive tissue protector, with the property of minimum scattering providing a high energy density in an exposure area that is well defined and as small as possible.

According to a preferred aspect of the present invention, the soft-tissue positioning part comprises a lip part arranged, with respect to the jaw part, in such a way as to keep the patient's lips outside the effective range of the radiation during surgery. According to the invention, therefore, the soft-tissue positioning part comprises either only a tongue part or only a lip part or both a tongue part and a lip part. Since the tongue part is located predominantly within the oral cavity while tissue protector is in the applied condition, it is possible or even required for the lip part to be connected to the jaw part rather than to the tongue part, particularly if it is designed and adapted as a part serving to support the patient's upper lip. Therefore, the classification or subdivision into soft-tissue part and jaw part according to the invention may be purely functional, with the tongue part and the lip part representing parts of the soft-tissue positioning part not being connected to each other integrally. Specifically, the above mentioned detachable connection may be arranged between the tongue part and the jaw part, while the connection between the jaw part and the lip part may be integral. Furthermore, the lip part may be formed from spatially separate lip part portions. Advantageously, the connection between the lip part and the jaw part is such that in the applied condition of the tissue protector, the lip part is displaceable relative to the jaw part.

According to a preferred aspect of the present invention, the soft-tissue positioning part comprises a cheek part arranged with respect to the jaw part in such a way that the patient's cheeks are located outside the effective range of the radiation during surgery. What is true for the cheek part is analogously true for the lip part. Specifically, the cheek part may be comprised of a plurality of cheek part portions that are neither connected to each other nor to the tongue part or to the lip part.

In accordance with an advantageous aspect of the present invention, the inventive tissue protector comprises at least one radiation transmission area, the material and/or wall thickness of which is/are adapted to shift the maximum of radiation into a surface area of the tissue. In this way it is possible to influence or optimize the radiation dose at the very location of the tumor. If, for example, electron rays are used for treatment, then due to the weak interaction between the tissue and the electrons entering the tissue and still having a very high kinetic energy there, a large part of this energy is deposited in deeper tissue layers. In other words: The depth dose curve for electrons showing the dependency of the radiation dose on the depth of penetration has a maximum at a depth that is dependent on the kinetic energy of the electrons and different from zero. Under certain conditions the energy absorbed in a surface area may therefore not be sufficient to destroy a tumor located there. The radiation accordingly has to be passed through and partially absorbed by a so-called tissue-equivalent material before entering the tissue. This maximum can be displaced to the location of the tumor by means of a thickening of the plastic layer of the inventive tissue detector relative to the other wall thicknesses of the tissue detector in one position or in a plurality of positions presently referred to as radiation transmission area(s). Depending on the tumor, the thickness of the plastic layer of the inventive tissue protector at such a radiation transmission area, the position of which corresponds to the location of the tumor in the applied condition of the tissue protector, is about 1 cm. The effect of the “thickened” radiation transmission areas may be likened to a moderator for producing thermal neutrons in a nuclear reactor. The described effect may thus be caused, as was described above, either by an appropriate thickness of the wall in the radiation transmission area and/or by an appropriate material. In addition, the material of the radiation transmission area and the material of the remaining areas of the tissue protector may be identical or different.

In accordance with the present invention, a tissue protector for protecting healthy tissue of a patient from radiation exposure during brachytherapy comprises a jaw part for generating a raised bite (just as with the above-described tissue protector for protecting healthy tissue of a patient from radiation exposure during teletherapy), wherein the jaw part comprises at least one application catheter. As a general rule an iridium radiator, in some cases, for example, also a cobalt radiator which emits gamma-rays having an energy of about 4-25 MeV is taken close to the tumor by means of the at least one application catheter which is advantageously incorporated into the jaw part at a distance of about 3-5 mm from the mucosa surface. In a case of more than one application catheter, these are arranged at intervals of about 5 mm from each other. Advantageously, the application catheter is incorporated in the tissue protector in the form of a channel and thereby acts as a light conductor.

In accordance with an advantageous aspect of the present invention, the tissue protector comprises a soft-tissue positioning part having the features defined above in connection with the tissue protector for use in teletherapy. This is beneficial in that in brachytherapy also, healthy tissue can be held outside the effective range of said radiation unless, as is usually the case, the radiation source is not introduced directly into the tissue of the tumor or directly adjacent the tumor tissue, but a comparatively large distance is provided between the application catheter and the tissue to be exposed to radiation.

In accordance with an advantageous aspect of the present invention, the tissue protector comprises at least one lead plate for radiation protection of said healthy tissue that is preferably configured to be exchangeable, the at least one lead plate being attached in the manner of a snap fastener system. The at least one lead plate ensures the protection of the healthy tissue, e.g., the lips, the cheek mucosa, the tongue, the hard palate, the alveolar ridge, etc. Depending on the radiation dose—the energy of the rays is in the range of kilovolts—the thickness of the lead plates is about 2-3 mm. In view of the exchangeability, i.e., specifically the detachability of the lead plates, it is possible to restrict the customarily used two protection devices to only a single one. This is because usually, a first device made of plastic material and without any lead plates is used for planning a brachytherapy, and a second device including lead plates is used for carrying out the brachytherapy.

In accordance with an advantageous aspect of the present invention, the opening has a median arrangement in the jaw part. As an alternative, the opening may be displaced from that position in a distal direction so as to improve, e.g., viewing of a tumor that is located rather at the lateral margin of the tongue.

In accordance with an advantageous aspect of the present invention, a caudal rim of said jaw part is bisected by a slit extending from said opening in a caudal direction. Due to this bisection, the radiotherapist's field of vision is extended downwards without having to dispense with the advantages mentioned in the foregoing. This is beneficial particularly in view of the position of the tongue that is depressed by the tongue part, i.e., located at a lower position, during treatment. The width of the slit is a compromise between stability and stiffness of the inventive tissue protector on the one hand and a maximized field of vision on the other hand, and in accordance with a preferred aspect of the present invention corresponds to the lateral extension of the patient's lower incisors; that is, the jaw part, the row of lower jaw teeth is enclosed only from teeth 38-33 and 48-43 (regarding the teeth, the usual dental numbering or notation is always being used). In accordance with the invention, the cranial edge of the jaw part is always continuous to thus have no slit extending accordingly from the opening in the cranial direction. The tissue protector of the invention thus encloses all of the teeth 38-33 and 48-33 of the upper jaw, thus favoring stability and manipulation or handling of the tissue protector.

In accordance with an advantageous aspect of the present invention, the tissue protector comprises at least one fixation element for its fixation. This fixation is required especially during radiation therapy of tumors of the head or neck and also of cerebral tumors, and is carried out in that the at least one fixation element is connected via an attachment system to a radiation table or a face bow or the like, whereby complete immobilization and reproducible positioning of the tissue protector and consequently of the head is achieved. In this way it is possible, for instance, to do away with a conventional synthetic plaster mask for the fixation of the head. The main effect of the fixation is the immobilization of the upper and lower jaws by the inventive tissue protector. The at least one fixation element advantageously is integrally connected to the jaw part and has a fork-shaped structure with two prongs. In the interspace of the prongs a connecting part extending to a face bow is arranged, which face bow in turn is fixed to an occiputal shell, which preferably is custom-made, or to a table mounting system. For additional stability, the face bow is advantageously supported at the root of the nose—the nasion—by means of a so-called nasion support that advantageously is also custom-made. For immobilization of the mandible it is furthermore advantageous to provide a chin cap that is also attached to the occiputal shell.

In accordance with an advantageous aspect of the present invention, protection of healthy tissue is improved in that the jaw part is configured in such a way that the teeth's crowns of at least a part of the teeth of the lower and upper jaw are enclosed by the jaw part. What teeth's crowns are affected hereby depends i. a. on the location of the tumor and the number of the teeth.

In accordance with an advantageous aspect of the present invention, the tissue protector comprises a sensor for detecting the radiation exposure. On the one hand, this serves the purpose of judging and verifying whether the projected dose reaches its target, i.e., the tumor. On the other hand this serves the purpose of being able to judge whether or not the dose is exceeded at other locations that should be spared.

In accordance with an advantageous aspect, the tissue protector comprises at least one tumor marking. This is advantageous in that it is no longer necessary to tattoo the tumor on the tongue, in the lip or cheek area etc., as is commonly done, because the tumor is marked in an appropriate location on the transparent tissue protector. The marking may advantageously be covered or sealed by a layer of a synthetic material. In this way the original position and size of the tumor are apparent even after the radiation treatment. The patient thus is spared a general anesthetic and the associated hospital stay. The marking has an additional advantage in that the treatment process is discernable if the marking originally is of the same size as the tumor at the beginning of the treatment.

In accordance with an advantageous aspect of the present invention, the jaw part and/or the soft-tissue positioning part are/is formed of a solid synthetic material, with “solid” presently having the meaning that a constant raised bite and constant spatial relationships between the upper and lower jaws and the tongue are guaranteed. This, however, does not exclude a certain elasticity of shape. On the contrary. In order to be able to optimally serve the functions described in the foregoing, it is advantageous if the teeth cause a slight elastic impression on the surface of the jaw and soft-tissue positioning parts, especially of the tongue part.

In accordance with an advantageous aspect of the present invention, the tissue protector is individually adapted to the patient. As a result, both the precision of the surgical intervention and the reproducibility of the relevant positions of upper jaw, lower jaw and tongue during the various sessions are enhanced, and so is the wearing comfort of the tissue protector for the patient, which contributes to reducing mucosa irritation, for example.

These and other objects, features and advantages of the present invention will become more clearly evident from the following detailed description that is made with reference to the attached drawings, wherein:

FIG. 1 is a front view of a tissue protector according to an embodiment of the present invention;

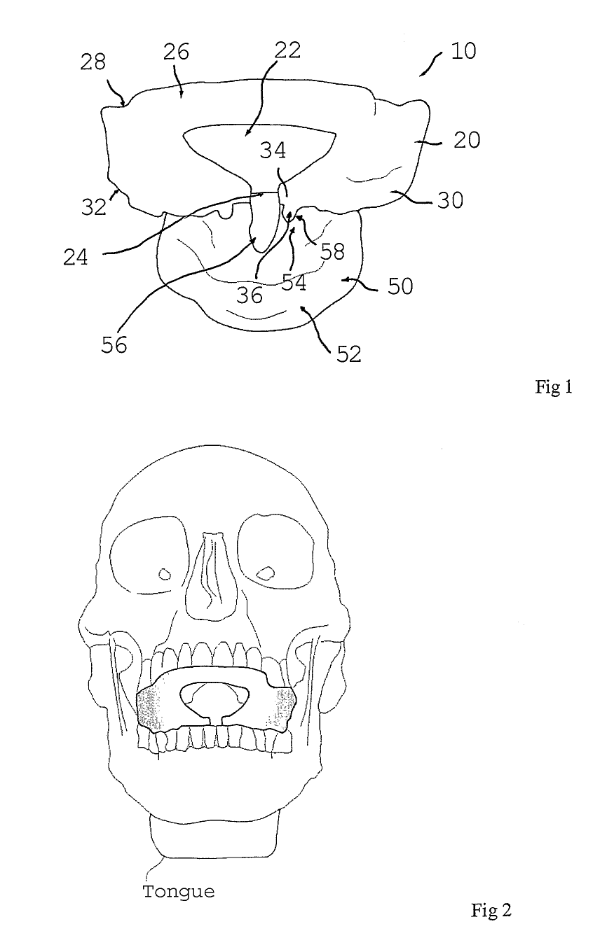

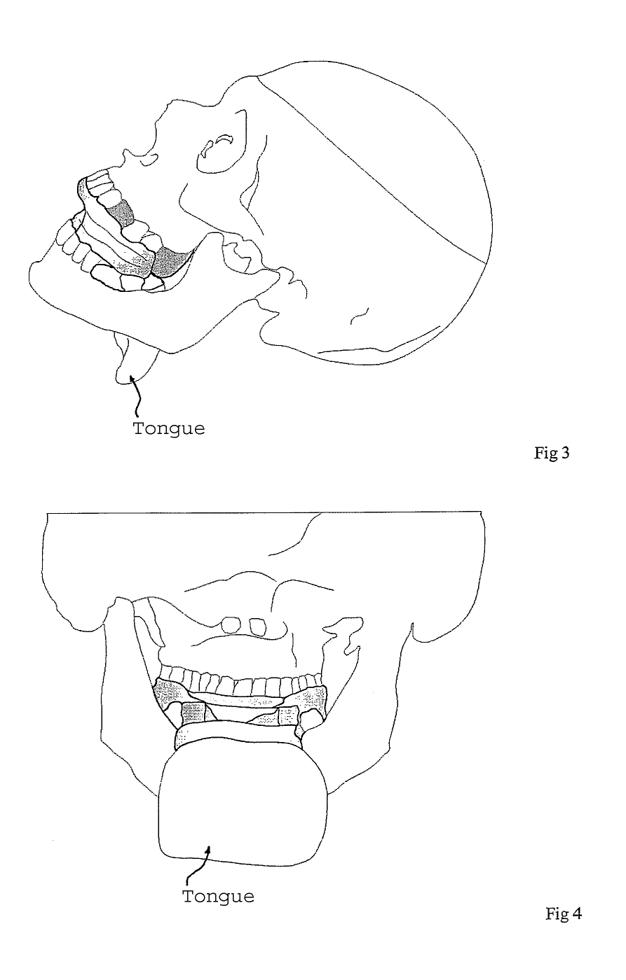

FIGS. 2 to 4 show the tissue protector of FIG. 1, positioned in a human skull, in a front view, a side view, and a back view;

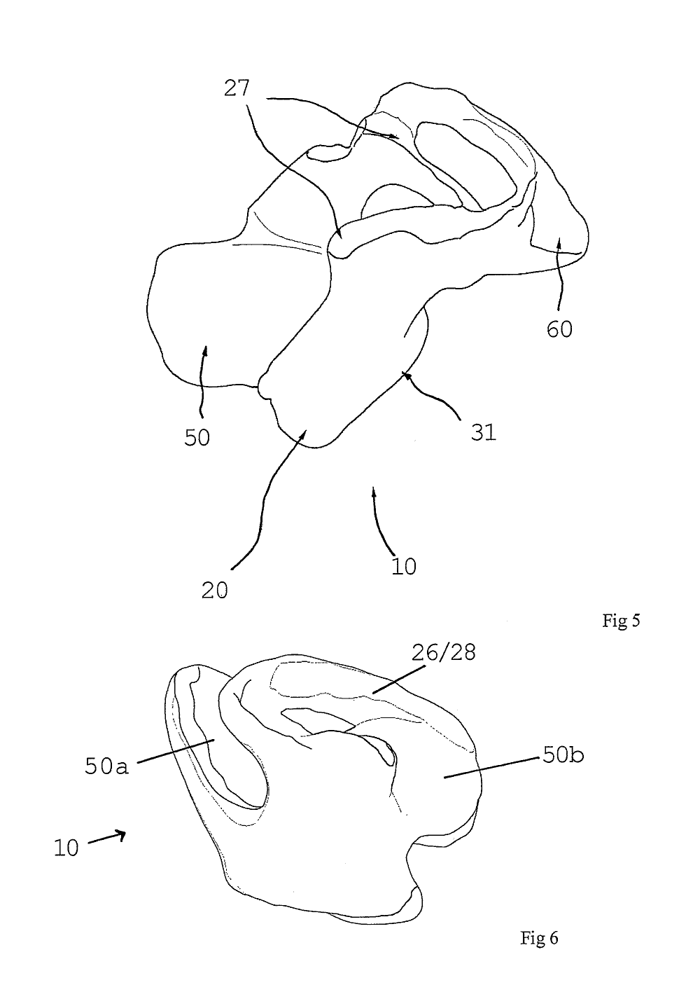

FIGS. 5 to 8 show perspective views of the tissue protector according to further embodiments of the present invention; and

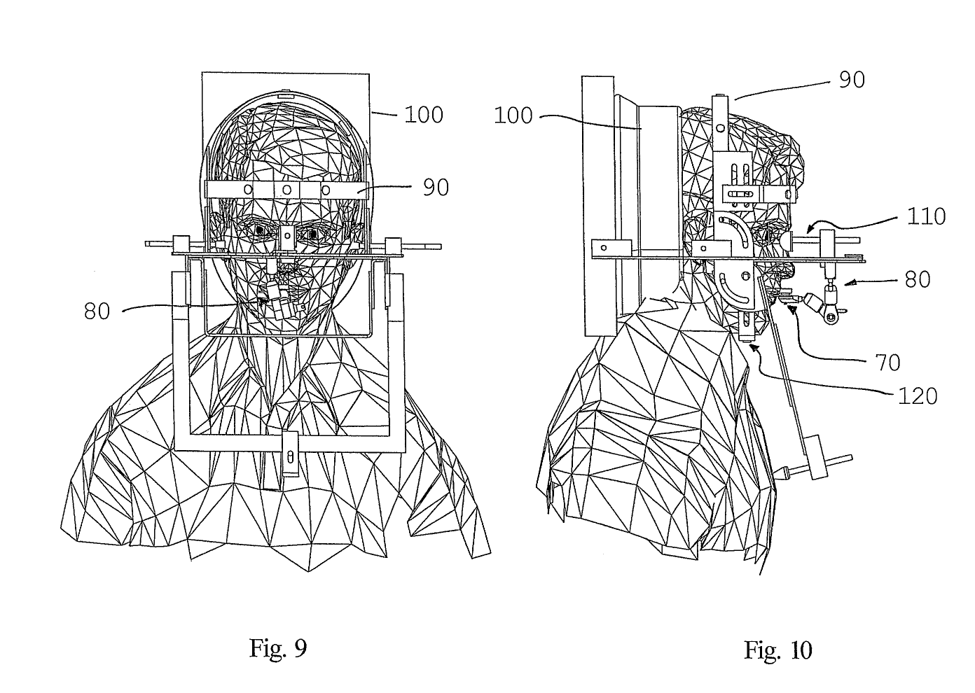

FIG. 9 and FIG. 10 are a front view and a side view showing the inventive tissue protector in combination with a device for fixing the tissue protector on a patient's head.

FIG. 1 shows a front view of a tissue protector according to an embodiment of the present invention which is generally denoted by 10. The tissue protector 10 comprises a jaw part 20 and a tongue part 50.

In its longitudinal direction the jaw part 20 is configured in the shape of a dental arch, i.e., in the inserted condition it extends along the upper and lower dental arches, as is shown in FIGS. 2 to 4. In its frontal-medial section portion the jaw part 20 is furthermore provided with a generally triangular opening 22 continuing in a caudal direction (down-wards in FIG. 1) into a slit 24 that opens downwards. The jaw part 20 comprises an upper jaw portion 26 having an upper tooth bearing or support surface 28 and a lower jaw portion 30 having a lower tooth bearing or support surface 32 that is integrally connected to the upper jaw portion 26. The lower jaw portion 30 is further provided with a male part section 34 extending in the lingual direction, from which a longitudinal protrusion 36 also extending along the entire length of the male part section 34 protrudes in a caudal direction. Due to the opening 22 and the slit 24, the lower jaw portion 30 including its male part 34 is divided into left and right sections. When applied to a fully dentulous patient, the lower jaw portion 30 thus encloses only the lower jaw teeth 38-33 and 48-43; the lower incisors are left out. The upper jaw portion 26, in contrast, is formed to be continuous, to thus enclose all the teeth 18-11 and 28-21 when applied to a fully dentulous patient.

The tongue part 50 comprises a tongue depressing portion 52 and a female part 54 integrally connected thereto. The male part 54 has a vertical slit 56 separating it into left and right sections. The female part 54 furthermore has a groove 58 formed complementarily with the longitudinal protrusion 36 of the female part 54 wherein the longitudinal protrusion 36 is accommodated when the inventive tissue protector 10 is inserted in the patient's mouth, so as to establish a releasable connection of the type of a female-part male-part or tongue-and-groove joint between the jaw part 20 and the tongue part 50 which is nevertheless sufficiently stable for the treatment. The tongue depressing portion 52 is adapted to the curvature of the back of the tongue and is capable of depressing the tongue in a well-defined and reproducible position below the teeth of the lower jaw. As is shown in FIG. 1, the slit 24 of the upper jaw portion 30 of the jaw part 20 continues via the female part 54 into the tongue depressing portion 52. As is shown in FIG. 1, in a cross-sectional view of the female part—male part connection the contact surface between the female part 54 and the male part 34 is visible as an S-shaped line illustrating the mutual engagement of longitudinal protrusion 36 and groove 58.

FIGS. 2 to 4 show the tissue protector 10 of FIG. 1 in the inserted condition. What is clearly visible is the raised bite and the depression of the tongue accomplished by the tissue protector 10, enabling an irradiation under visual monitoring through the opening 22 and the slit 24 without posing a risk to the teeth.

According to this embodiment, the tissue protector 10 is made of a material that is solid but nevertheless allows an easy elastic impression by the teeth and that can be transirradiated nearly without any loss. Apart from this, the tissue protector may be cleaned easily after every session using a tooth brush and water, for example.

FIG. 5 shows a further embodiment of the tissue protector 10 of the present invention. The tissue protector 10 is formed as a monobloc, wherein the jaw part 20 comprising an upper jaw masticating ridge 27 and a lower jaw masticating ridge 31 is integrally connected to the tongue part 50. The tissue protector 10 further comprises a lip part 60 integrally connected to the jaw-tongue part.

FIG. 6 shows another embodiment of the tissue protector 10 of the present invention. The tissue protector 10 again is formed as a monobloc. Protruding to the left side is a front tongue subpart 50a of the tongue part 50, and protruding to the right side is a rear tongue subpart 50b of the tongue part 50, which jointly ensure that the tongue is urged in a cranial-anterior direction. As in the embodiments described in the foregoing, reference numerals 26 and 28 show the upper jaw portion and the upper tooth bearing or support surface.

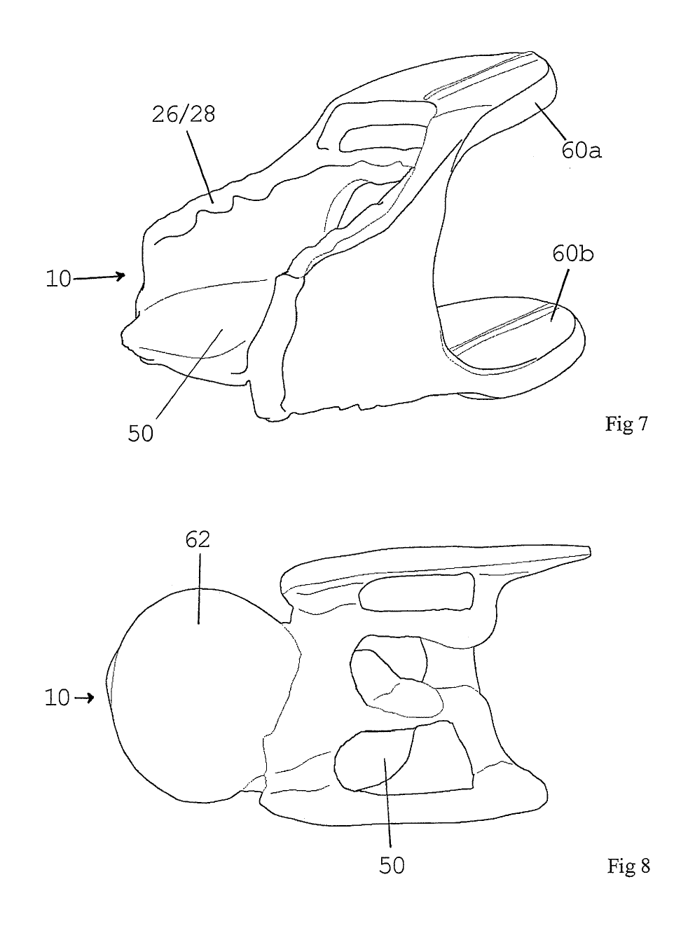

FIG. 7 shows another embodiment of the tissue protector 10 of the present invention. Distinctly protruding to the right side are an upper lip subpart 60a and a lower lip sub-part 60b. In the middle, between the upper jaw portion 26 and the tooth bearing or supporting surface 28, there is the tongue part 50 immobilizing the tongue which exerts a pressure against the tongue part 50 from below due to its inherent tonicity.

FIG. 8 shows a further embodiment of the tissue protector 10 of the present invention. In this embodiment, a cheek part 62 protrudes to the left—laterally to the right relative to the patient's body. Through openings in the tissue protector 10, in the rear the tongue part 50 is visible which serves in this embodiment to hold the tongue away in the same direction as the cheek part 62 does with the right cheek of the patient.

Although this is not shown in the individual figures, all of the described embodiments may comprise, in the scope of protection as defined in the claims and in accordance with their discussion in the introductory portion of the description, at least one radiation transmission region, the material and/or wall thickness of which is adapted to shift the radiation maximum of the radiation into a surface area of the tissue, at least one application catheter that advantageously is incorporated in the jaw part at a distance of about 3-5 mm from the surface of the mucosa and through which an iridium radiator, for example, is taken as close as possible to the tumor, and/or at least one lead plate for the protection of healthy tissue that advantageously is exchangeable, wherein the attachment of the at least one lead plate is effected in the manner of a snap fastener system.

FIGS. 9 and 10 show the inventive tissue protector in combination with an apparatus for fixing the tissue protector on the head of a patient. Fixation is required especially during the radiation therapy of head or neck tumors and also in the case of cerebral tumors. To this end, the tissue protector comprises a fixation element 70 that is connected via an attachment system 80 to an exposure table (not shown) or to a face bow 90 that is known per se, or the like, so that a complete immobilization and reproducible positioning of the tissue protector with respect to the head of the patient is achieved. In this way it is possible to do away with a conventional mask made of synthetic plaster for the fixation of the head. The main effect of the fixation here is the immobilization of the lower and upper jaws by the inventive tissue protector. The fixation element 70 advantageously is integrally connected to the jaw part 20 and has a substantially fork-like structure with two prongs which projects outwardly from the jaw part 20. In the interstice between the prongs a connecting part is arranged that leads to the face bow 90 which, in turn, is fixed to a preferably custom-made occiputal shell or to the table mounting system. For additional stability the face bow 100—as shown in FIGS. 9 and 10—is advantageously supported at the root of the nose, the nasion, by means of a so-called nasion support 110 that advantageously is also custom-made. For immobilization of the lower jaw it is furthermore advantageous to provide—as shown in FIGS. 9 and 10—a chin cap 120 which is equally attached to the occiputal shell 100.

It should be noted here that the jaw part 20 proper, i.e., the jaw part 20 without the further elements of the inventive tissue protector, together with the device shown in FIGS. 9 and 10 constitutes a self-contained system for fixing or immobilizing the head of a patient during radiation therapy, for which protection may be applied for at a later date, for instance in the framework of a divisional application.

The tissue protector 10 according to the embodiment may be manufactured, e.g., by a method generally comprising the following steps:
preparing impressions of the patient's upper jaw, lower jaw and tongue;
preparing plaster models of the patient's upper jaw, lower jaw and tongue based on the impressions;
connecting the upper and lower jaw models in an articulated manner and adjusting a well-defined raised bite for preparing a bite raising model;
producing the jaw part based on the bite raising model; and
producing the tongue part.

Here the upper jaw impression and the tongue impression may be prepared concurrently. In order to prepare the upper jaw impression and the tongue impression it is furthermore possible to use an upper jaw modelling spoon, with the upper jaw being modelled on its upper side and the tongue on its lower side. The jaw part may advantageously be produced using a synthetic material scattering technique. Advantageously, the step of the polymerization of the male part may be included in the step of producing the jaw part. For manufacturing the tongue part it is furthermore advantageous if the plaster model of the tongue is placed in the plaster model of the lower jaw in such a way that the plaster model of the tongue is positioned below the teeth's crowns of the plaster model of the jaw part, and the tongue part is polymerized onto the dorsum of the plaster model of the tongue.

By way of example, the method for manufacturing the inventive tissue protector may specifically be carried out as follows:

At first, alginate impressions of the upper and lower jaws of the patient are taken. To this end, the impression material is mixed with water having a temperature of exactly 20° C. Subsequently the impression spoon of a soft synthetic material is inserted, jointly with the material, into the patient's mouth and left there for 10 minutes. After removal, the shrinkage has to be awaited for at least one hour before the impressions may be cast.

For casting the models, gypseous alabaster is used that is mixed in a mixing ratio of 200 g of gypsum/75 ml of warm water having a temperature of 30 degrees.

In cases of edentulous persons the checkbite is carried out with the aid of possibly existing prostheses, otherwise by means of bite templates individually made of a light-cured synthetic material using arrow registrate according to Gerber. In case of a dentulous person, two wax strips having a length of 1.5 cm are used in the molar area as a bite block registrate.

Having prepared the registrate in a centrical position, this has to be verified in a repeated checkbite. In total, five attempts in the centrical position have to be reproducible. Thereafter, the position of the upper jaw is transferred via a face bow into an articulator, i.e., an apparatus for the simulation of mandibular joint movements.

Subsequently the plaster models are mounted in the articulator. To this end, water with an addition of a 3% bicarbonate solution is used for attachment of the plaster models.

For manufacturing the apparatus, an emerald-blue, transparent synthetic material having air inclusions is used. The particle or grain size is 100-110 micrometers. After stirring, a rise time of exactly 60 minutes has to elapse before the synthetic material can be further processed. In the next step, the air inclusions are introduced by means of compressed air. Thereafter, the synthetic material is directly applied onto the plaster model in the articulator without any insulator and modelled by means of a lancet-shaped nickel-titanium applicator, wherein care must be taken to generate a groove having a width of exactly 5 mm on the upper jaw model along the jaw ridge whose depth must not exceed 5 mm. Prior to that, the incisal pin was elevated by 45 mm.

Subsequent processing is carried with the aid of to the above-mentioned synthetic material by means of 5 μm staggered-toothed hard metal milling machines in descending diameter of the working part at a rotational speed of 80,000 rpm.

The following polish is done by means of Canarian volcano pumice for a period of at least 20 minutes without water cooling in order to arrive at an improved final polymerization. Then, repolishing with 80% precipitate chalk is carried our for 31 minutes.

At the end of the manufacturing process, a check is performed. To this end, the alignment of the globules of synthetic material is examined using an electron microscope at 10,000× magnification in order to be able to judge radiation scattering.

Finally, the device is adapted on the patient, i.e. the occlusal height, the centrical relation and possibly existing dents or pressure marks are detected and appropriate corrections are carried out.

Although the present invention is disclosed with reference to the preferred embodiments in order to enable a better understanding thereof, it should be noted that the invention can be implemented in different ways without departing from the scope of the invention. Therefore, the invention should be construed such as to include any possible embodiments and aspects for the shown embodiments that may be realized without departing from the scope of the invention as defined in the attached claims.

### LIST OF REFERENCE NUMERALS

10 tissue protector
20 jaw part
22 opening in 20
24 slit in 20
26 upper jaw portion
27 upper jaw mastication ridge
28 upper tooth bearing or support surface
30 lower jaw portion
31 lower jaw mastication ridge
32 lower tooth bearing or support surface
34 male part section
36 longitudinal protrusion at 34
50 tongue part
50a front tongue subpart
50b back tongue subpart
52 tongue depressing portion
54 female part section
56 slit
58 groove in 54
60 lip part
60a upper lip subpart
60b lower lip subpart
62 cheek part

1. A tissue protector for protecting healthy tissue of a patient from radiation exposure during teletherapy, comprising a jaw part for generating a raised bite, and a soft-tissue positioning part connected to said jaw part for positioning a soft-tissue of said patient, said jaw part having an opening for visual control of a surgical area of said patient.

2. The tissue protector of claim 1, characterized in that there is provided a detachable connection between said jaw part and said soft-tissue positioning part.

3. The tissue protector of claim 2, characterized in that said detachable connection is of the type of a male part- female part-system.

4. The tissue protector of claim 3, characterized in that said female part is formed in said soft-tissue positioning part and has a longitudinal direction of the form of a dental arch along which a groove is formed that is S-shaped in a plane orthogonal to said longitudinal direction, and in that said male part is formed in said jaw part and has a longitudinal protrusion complementarily formed with respect to said S-shaped groove.

5. The tissue protector of claim 3, characterized in that said soft-tissue positioning part comprises a tongue part for depressing the patient's tongue.

6. The tissue protector of claim 5, characterized in that said tongue part comprises a tongue depressing portion connected to said male part.

7. The tissue protector of claim 6, characterized in that said tongue depressing portion has an essentially tongue-shaped frontal cross section.

8. The tissue protector of claim 1, characterized in that said soft-tissue positioning part comprises a lip part arranged with respect to said jaw part in such a way that the patient's lips are located outside the effective range of said radiation during surgery.

9. The tissue protector of claim 1, characterized in that said soft-tissue positioning part comprises a cheek part arranged with respect to said jaw part in such a way that the patient's cheeks are located outside the effective range of said radiation during surgery.

10. The tissue protector of claim 1, characterized by being provided with at least one transirradiation area, the material and/or wall thickness of which is configured to shift the maximum of radiation into a surface area of the tissue.

11. A tissue protector for protecting healthy tissue of a patient from radiation during brachytherapy, said tissue protector comprising a jaw part for generating a raised bite and being provided with at least one application catheter.

12. The tissue protector of claim 11, characterized by comprising a soft-tissue positioning part detachably connected to said jaw part for positioning a soft-tissue of said patient.

13. The tissue protector of claim 1, characterized by comprising at least one lead plate for radiation protection of said healthy tissue.

14. The tissue protector of claim 13, characterized in that said at least one lead plate is configured to be exchangeable.

15. The tissue protector of claim 13, characterized in that said at least one lead plate is attached in the manner of a snap fastener system.

16. The tissue protector of claim 1, characterized in that said opening is arranged medianly.

17. The tissue protector of claim 1, characterized in that a caudal rim of said jaw part is bisected by a slit extending from said opening.

18. The tissue protector of claim 17, characterized in that the width of said slit corresponds to the lateral extension of the patient's lower incisors.

19. The tissue protector of claim 1, characterized in that said jaw part is configured in such a way that said jaw part at least partly encloses the teeth's crowns of at least some of the teeth of the lower and upper jaws.

20. The tissue protector of claim 1, characterized by comprising at least one fixing element for its fixation.

21. The tissue protector of claim 1, characterized by comprising at least one sensor for detecting the radiation exposure.

22. The tissue protector of claim 1, characterized by comprising at least one tumor marking.

23. The tissue protector of claim 1, characterized in that said jaw part and/or said soft-tissue positioning part are/is composed of a rigid synthetic material.

24. The tissue protector of claim 1, characterized in that said tissue protector is individually adapted to said patient.

25. The tissue protector of claim 12, characterized by comprising at least one lead plate for radiation protection of said healthy tissue.

26. The tissue protector of claim 25, characterized in that said at least one lead plate is configured to be exchangeable.

27. The tissue protector of claim 25, characterized in that said at least one lead plate is attached in the manner of a snap fastener system.

28. The tissue protector of claim 12, characterized in that said jaw part is configured in such a way that said jaw part at least partly encloses the teeth's crowns of at least some of the teeth of the lower and upper jaws.

29. The tissue protector of claim 12, characterized by comprising at least one fixing element for its fixation.

30. The tissue protector of claim 12, characterized by comprising at least one sensor for detecting the radiation exposure.

31. The tissue protector of claim 12, characterized by comprising at least one tumor marking.

32. The tissue protector of claim 12, characterized in that said jaw part and/or said soft-tissue positioning part are/is composed of a rigid synthetic material.

33. The tissue protector of claim 12, characterized in that said tissue protector is individually adapted to said patient.
